(19) United States
(12) Patent Application Publication
(10) Pub. No.: US 2021/0204106 A1
(43) Pub. Date: Jul. 1, 2021

(54) EVENT ALERTING USING A COMMUNICATIONS SYSTEM

(71) Applicant: Nokia Solutions and Networks Oy, Espoo (FI)

(72) Inventors: Rajesh Babu NATARAJAN, Bangalore (IN); Paromita CHINTAN SHAH, Bangalore (IN)

(21) Appl. No.: 16/754,966

(22) PCT Filed: Oct. 10, 2018
(86) PCT No.: PCT/EP2018/077561

§ 371 Date: Apr. 9, 2020

(30) Foreign Application Priority Data
Oct. 12, 2017 (IN) 201741036336

(51) Int. Cl. H04W 4/90; G08B 29/18; H04W 4/021; G08B 27/00

(52) U.S. Cl. CPC H04W 4/90; G08B 27/006; H04W 4/021; G08B 29/18

(57) ABSTRACT

Systems and methods for event alerting using a communications system are disclosed. An example comprises receiving a first message over a communications network from a first communications device, the message relating to an emergency event, and determining the geographic location of the first communications device. Transmission of an alert message is caused to one or more second communications devices within a first area based on the determined location, the alert message providing an indication of the emergency event and prompting feedback by means of the second communications devices relating to the emergency event. One or more feedback messages may be received relating to the emergency event from one or more of the second communications devices.

### FIELD

This disclosure relates to methods and systems for event alerting using a communications system, particularly, though not exclusively, for causing alerts relating to an emergency event to be transmitted over a cellular network.

### BACKGROUND

Typically, emergency events are reported by members of the public by them calling or texting either an emergency service, such as the police, or by calling a dedicated emergency number such as 911 in the USA, or 999 in the UK. Some such reports may be hoaxes or prank calls. This causes inconvenience to the emergency services called upon to respond, wastes money, and potentially puts others at risk because such resources are diverted away from genuine emergency events.

Furthermore, even when a genuine report is made, it can be difficult in the short term to ascertain the specific affected area, and how widespread the event and its effects are.

The occurrence of certain emergency events can have significant implications for public safety and infrastructure. Examples include earthquakes, hurricanes, fires, explosions, and terrorist attacks. It is known for some countries to provide an alert system for its inhabitants in the case of an occurring event. For example, some telecommunications networks may issue alert messages to all devices the network can contact, to raise the alarm. This is usually in response to a request from a governmental agency, such as the emergency services or a government department. For example, some cellular networks provide a cell broadcast center (CBC) which can broadcast alert messages to all devices within the coverage area of their network. However, the same aforementioned problems potentially remain.

### SUMMARY

A first aspect provides a method comprising: receiving a first message over a communications network from a first communications device, the message relating to an emergency event; determining the geographic location of the first communications device; causing transmission of an alert message to one or more second communications devices within a first area based on the determined location, the alert message providing an indication of the emergency event and prompting feedback by means of the second communications devices relating to the emergency event; and receiving one or more feedback messages relating to the emergency event from one or more of the second communications devices.

The alert message may comprise a link to a webpage or the like for prompting the said feedback.

The method may further comprise determining the validity of the first message based on the received feedback messages.

Determining the validity may comprise identifying the first message as valid if a predetermined number of feedback messages positively confirming the emergency event are received.

Determining the validity may comprise identifying the first message as valid if the predetermined number of feedback messages are received within a predetermined time frame from when the alert message was caused to be transmitted.

Determining the validity may comprise identifying the first message as valid if the predetermined number of feedback messages provide feedback determined as being consistent with each other.

The received feedback message may comprise observational data relating to the emergency event.

The observational data may relate to one or more of visibility of the emergency event, audibility of the emergency event, smell from the emergency event, relative location.

The received feedback messages may comprise an uploaded data file representing one or more of a photograph, video, and audio clip.

The received feedback message may comprises the geographic location of the second communications device from which the feedback message was received.

Causing transmission of the alert message may comprise causing transmission of a feedback form prompting input of the feedback and for sending to a predetermined system.

The transmitted feedback form may comprise one or more radio buttons, each associated with a predefined observation relating to the emergency event.

The one or more radio buttons may prompt confirmation of one or more of visibility of the emergency event, audibility of the emergency event, smell from the emergency event, relative location.

The transmitted feedback form may comprise one or more alphanumeric text entry fields, each associated with a predefined observation relating to the emergency event, for receiving alphanumeric text relating to the emergency event.

The transmitted feedback form may further comprise a means to upload or attach one or more of a photograph, video, and audio clip.

The transmitted feedback form may automatically open one or more of a camera or audio recording application at the one or more second communications devices in response to being received, opened or activated.

Causing transmission of the alert message to second communications devices within a first area may comprise causing transmission only to a first sub-set of cells of a cellular communications network, the first sub-set being determined based on the received geographic location.

The first sub-set of cells may comprise and/or surround the received geographic location.

The first sub-set of cells may surround a cell having an associated base station which is closest to the first communications device.

The alert message may be caused to be sent as a broadcast message.

The alert message may be caused to be sent as a cell broadcast from a cell broadcast centre of a cellular network.

The method may further comprise causing transmission of the alert message to one or more communications devices within a second area based on the determined location, the second area being different from the first area; and receiving one or more feedback messages relating to the emergency event from one or more of the communications devices in the second area.

Causing transmission of the alert message to the communications devices within the second area may comprise causing transmission only to a second sub-set of cells of the cellular communications network, different from the first sub-set of cells.

The second area may be determined based on the determined location and environmental data, e.g. weather conditions and user feedback data analysis from the first area.

The method may further comprise generating a map, being a two or more-dimensional graphical representation based on the feedback messages indicative of positive feedback in relation to the first communications device.

A second aspect provides a method comprising: receiving a request from an event notifier of an event and a geographical area for transmission of an event alert message to communications devices; determining one or more nodes of a communications network based on the geographical area; and transmitting an alert message to communications devices by means of the determined one or more nodes of the communications network, the alert comprising a means of inputting feedback at the communications devices upon receiving the alert message.

A third aspect provides a computer program comprising instructions that when executed by a computer program control it to perform the method of any preceding definition.

A fourth aspect provides a non-transitory computer-readable storage medium having stored thereon computer-readable code, which, when executed by at least one processor, causes the at least one processor to perform a method, comprising: receiving a first message over a communications network from a first communications device, the message relating to an emergency event; determining the geographic location of the first communications device; causing transmission of an alert message to one or more second communications devices within a first area based on the determined location, the alert message providing an indication of the emergency event and prompting feedback by means of the second communications devices relating to the emergency event; and receiving one or more feedback messages relating to the emergency event from one or more of the second communications devices.

A fifth aspect provides an apparatus, the apparatus having at least one processor and at least one memory having computer-readable code stored thereon which when executed controls the at least one processor: to receive a first message over a communications network from a first communications device, the message relating to an emergency event; to determine the geographic location of the first communications device; to cause transmission of an alert message to one or more second communications devices within a first area based on the determined location, the alert message providing an indication of the emergency event and prompting feedback by means of the second communications devices relating to the emergency event; and to receive one or more feedback messages relating to the emergency event from one or more of the second communications devices.

A sixth aspect provides an apparatus configured to perform the method of any previous method definition.

### BRIEF DESCRIPTION OF THE DRAWINGS

Example embodiments will now be described by way of non-limiting example with reference to the accompanying drawings, in which:

FIG. 1 is a block diagram of a first embodiment system for issuing alert messages to communications devices and receiving feedback data therefrom;

FIG. 2 is a flow diagram indicating in overview operations for issuing alert messages to communications devices and receiving feedback data therefrom according to an embodiment;

FIG. 3 is a flow diagram indicating additional operations that may follow those shown in FIG. 2;

FIG. 4 is a block diagram of a further embodiment system for issuing alert messages to communications devices and receiving feedback data therefrom, being a cellular communications embodiment;

FIG. 5 is a flow diagram indicating operations for issuing alert messages using the FIG. 4 system;

FIGS. 6a and 6b show a communications device with, respectively, an alert message and a feedback form, in accordance with embodiments;

FIG. 7 is a flow diagram showing how feedback messages may be used to determine a score indicative of how genuine a reported event is, in accordance with embodiments;

FIG. 8 is a schematic view of a geographic area comprising a plurality of cells, useful for understanding embodiments;

FIGS. 9a and 9b are schematic views of the FIG. 8 geographic area, useful for understanding embodiments relating to first, second and third areas;

FIG. 10 is a schematic diagram of components of a system according to an example embodiment; and

FIGS. 11a, 11b and 11c show tangible media, respectively a removable memory unit, a compact disc (CD) and hard disk drive (HDD) storing computer-readable code which when run by a computer perform operations according to embodiments.

### DETAILED DESCRIPTION OF PREFERRED EMBODIMENTS

Embodiments herein relate to methods and systems for event alerting using a communications system.

Embodiments herein relate particularly to methods and systems for alerting so-called emergency events, which are events that have possible consequences to public safety and infrastructure. Examples include earthquakes, hurricanes, tsunami, fires, explosions, and terrorist attacks. However, the methods and systems described herein can be applied to any type of reportable event.

In overview, some embodiments provide a way of determining or estimating the likelihood of a reported event being genuine or a hoax.

Some embodiments provide a way of ascertaining the specific affected area of the event and how widespread the event and its effects are.

In both cases, appropriate action can be taken accordingly, for example by alerting the emergency services as to the likelihood that the report is genuine or a hoax and/or the level of response needed to which geographic locations. For example, if a report is received of an event that has a high likelihood of being a hoax, a message may be sent to the appropriate responder, e.g. the police service, with an indication of the likelihood. The responder may dispatch officers to the scene, but may handle the response in a different way than an event determined to be genuine. If an event has a wide impact area, the appropriate number of responders can be dispatched.

Embodiments are described in the context of using a cellular communications network to transmit alert messages, for example using the aforementioned CBC of a cellular network or a related system. The cellular network may for example be a 3G, 4G or 5G cellular network, or indeed a future type of cellular network. Other types of communication network may be employed for similar purposes.

In overview, the methods and systems described comprise receiving an emergency event message from a first device, and causing transmission of an alert message to second devices within a first area of the communications network, based on the determined geolocation of the first device from which the event message emanated. The alert message serves to inform users of the second devices of the event, and also prompts feedback from those users relating to the event. In effect, a form of crowd feedback it utilised. Based on the received feedback, it can be determined a confidence level as to how genuine the initial event massage. Other decisions can be made based on the feedback, for example whether or not to issue one or more further alert messages to a different area of the communications network, for further feedback, and/or inferring the affected area or areas of the event.

The emergency event message may be a telephone call made to a national emergency operator, such as the 911 or 999 service in the USA and UK respectively. The message is a voice call that is converted into data form by the operator when generating an event report. The geolocation of the device may be relayed by the person making the call. If the call is made using a user equipment of a cellular communications network, the geolocation of the user equipment can be retrieved from, for example, the Evolved Serving Mobile Location Center (E-SMLC) of the network which determines the locations of user equipment using observed time difference of arrival (OTDOA.)

The emergency event message may alternatively comprise a text message, e.g. a SMS, or any form of message which may convey an event.

The first device can be any form of user equipment, for example a mobile telephone, smartphone, tablet computer or laptop.

The alert message can be any form of data message, and may be in the form of a short message service (SMS) message or a cell broadcast (CB) message. The alert message may indicate the type of event, such as earthquake, hurricane, tsunami, fire, explosion, or terrorist attack. The alert message may also indicate the determined location of the event. The alert message may also indicate advised action to take, such as evasive action.

The first area of the communications network may be any sub-area of the communications network, for example an area served by one or more nodes of the overall number of nodes which comprise the network. For example, in the context of a cellular network, the first area may be the area served by a limited number of one or more base stations. The second devices to which the alert message is sent may be any form of user equipment having a current geolocation within the first area. The second devices may comprise a mobile telephone, smartphone, tablet compute or laptop, for example.

Feedback may be prompted by means of a form included with the alert message. A link, e.g. a URL, may be included with the alert message. Activation of the link may cause opening on the second device a web-page accessed by the URL, which web-page prompts user-input of feedback. Alternatively methods of feedback include simply prompting respective users of the second devices to hit ‘reply’ for inputting feedback and sending it to the originating sender of the alert message. The use of a form, however, is useful in that it prompts specific information useful for determining whether the event is genuine and/or its geographical impact.

In some embodiments, one or more further alert messages may be caused to be transmitted to a different group of devices, e.g. third devices, within a different area of the communications network. This is to ‘build a picture’ of the geographical impact.

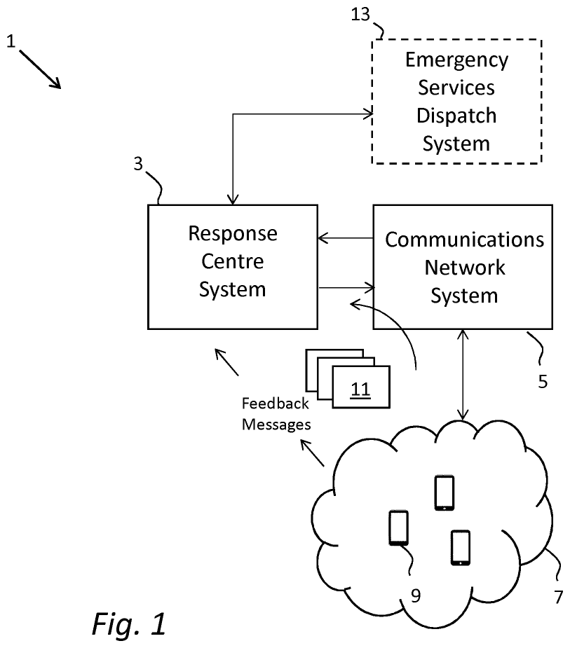

FIG. 1 is a block diagram of a generalised system 1 according to a first embodiment. The system 1 comprises a response centre system 3, a communications network system 5, and a communications network 7 associated with the communications network system. A plurality of communications devices 9, which may be one or more of mobile phones, smartphones, tablet computers, laptops etc. will typically be within the range of the communications network 7.

The response centre system 3 may be a system configured to communicate with an emergency services dispatch system 13 which is responsible for handling the dispatch of response units such as police officers, fire officers, coastguard, medical personnel, the armed forces and other such agencies. For example, the emergency services dispatch system 13 may be associated with the 911 or 999 facilities used in the USA or UK, respectively, to give examples.

The communications network system 5 is a part of the technical infrastructure of the communications network 7, and may comprise systems configured to transmit and receive data signals from nodes of the communications network 7 for routing to different parts of the communications network. It may be any form of radio controller, and comprises means for determining which geographic areas are covered by which of its base stations.

The response centre system 3 may be part of, or separate from, the communications network system 5.

The response centre system 3 may be operated by a private or public organisation, which may be external to the communications network system 5. Indeed, the response centre system 3 may operate in conjunction with multiple different networks and therefore with different communications network systems.

In connection with embodiments, an event may be reported by one of the communications devices 9 making a call, or sending an SMS, to the response centre system 3 via the communications network 7 and communications network system 5. Responsive to this, the response centre system 3 causes transmission of an alert message via the communications network system 5 and the communications network 7 to communications devices 9 and subsequently receives feedback messages 11 which are used to determine how genuine the reported event is and/or the reach of the event.

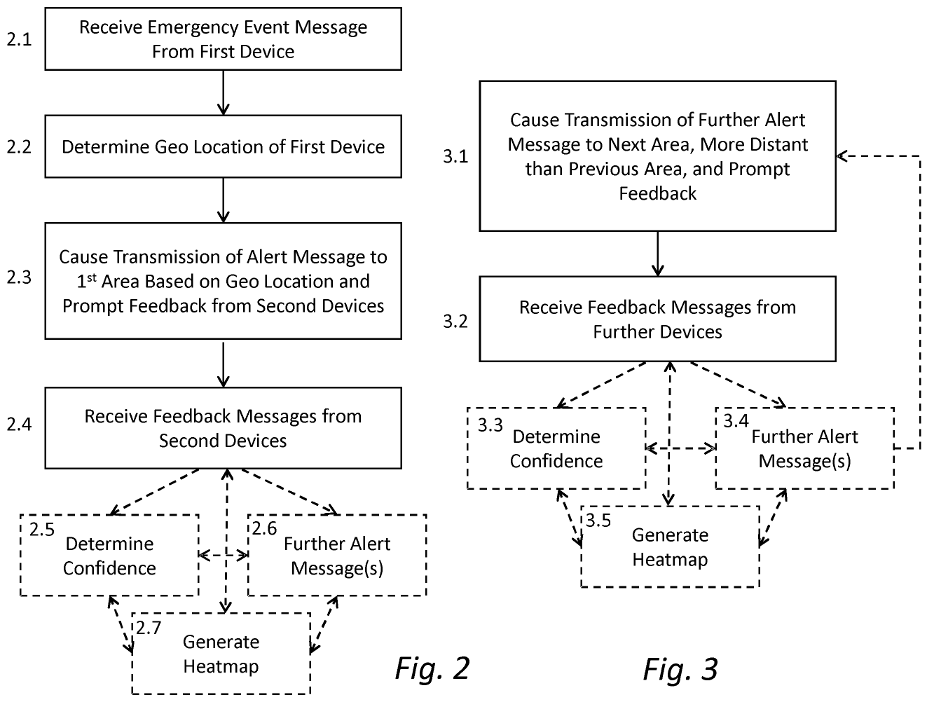

FIG. 2 is a flow diagram showing processing operations that may be performed by the response centre system 3, for example using one or more processing systems associated with the response centre system. Certain operations may be optional and certain operations may be re-ordered. The number of operations is not necessarily indicative of the order of performance.

A first operation 2.1 comprises receiving an emergency event message from a first, reporting, device.

A second operation 2.2 comprises determining the geographic location of the first device.

A third operation 2.3 comprises causing transmission of an alert message to a first area based on the geographic location and prompting feedback from second devices.

A fourth operation 2.4 comprises receiving feedback messages from one or more second devices.

A subsequent, optional operation 2.5 may comprise determining a confidence score 2.5 indicative of whether the reported event is genuine or a hoax. This may be performed based on the feedback messages. Another operation 2.6 may comprise causing transmission of one or more further alert messages, as will be explained below. Another operation 2.7 may comprise generating a heat map indicating in graphical form the affected area(s).

FIG. 3 is a flow diagram showing further processing operations that may be performed by the response centre 3, for example using a processing system associated with the response centre. Certain operations may be optional and certain operations may be re-ordered. The number of operations is not necessarily indicative of the order of performance.

The operations in FIG. 3 follow on from operation 2.6 of FIG. 2.

In an operation 3.1 transmission of a further alert message is caused to a next geographic area, more distant than the previous area, which prompts feedback in relation to the reported event. The next area may also be a sub-area of the communications network, and may not include any part of the previous area.

In an operation 3.2, feedback messages from further devices are received.

Subsequent operations 3.3, 3.4, 3.5 correspond to optional operations 2.5, 2.6, 2.7 mentioned above and, for example, may comprise causing transmission of still further alert messages to different geographic areas.

The first area may be a cell or cluster of cells closest to the determined geo location of the first, reporting device. The feedback received from this cell, or cluster of cells, may be reflective of observational data from users of the second devices. For example, the feedback may be requested based on what said users can see, hear or smell. If the feedback is consistent with the reported event, then it is likely that the report is genuine. If there is little or no feedback consistent with the reported event, then it is possible that the report may be a hoax. Given the number of second devices that will be in cells of a cellular network, for example, and the speed at which feedback can be prompted and received, the systems and method provide a good opportunity to ascertain what is happening at a given point in time.

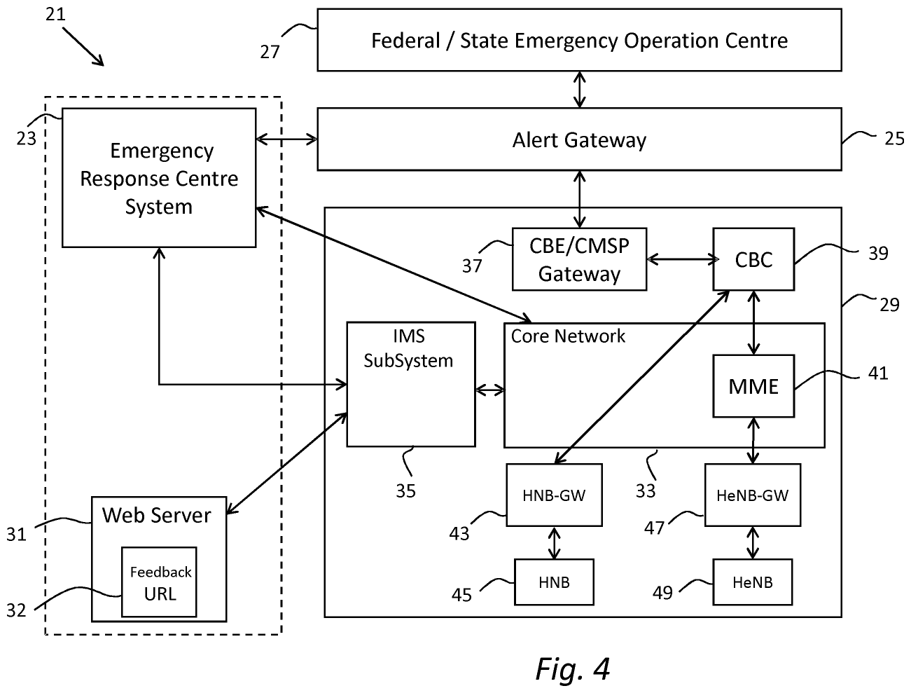

FIG. 4 is a block diagram of a more detailed system 21 for event alerting in accordance with embodiments. This embodiment is specific to cell broadcasting in a cellular telephone network, such as a 3G, LTE (4G), 5G or future cellular network.

The system 21 comprises an emergency response centre system 23, an alert gateway 25, a federal/state emergency operation centre 27, a cellular network 29 and a web server 31.

The cellular network 29 comprises a cell broadcast entity (CBE)/commercial mobile service providers (CMSP) gateway 37 which communicates with the cell broadcast center (CBC) 39. The CBC 39 is configured to broadcast (one to many) alert messages which may be in compliance with the Commercial Mobile Alert System (CMAS.) The CBC 39 has the information mapping the identity of base station cells to their respective geographic coverage areas. The CBC 39 in the present embodiment is configured to determine which cells to broadcast to based on the geolocation of the reported event.

A core network 33 comprises the routers and switches for routing calls and services to or from nodes that access the network via the access network. Within the core network 33 is a mobility management entity (MME) 41 (which is specific to LTE (4G) has an SBc-AP interface with the CBC for receiving SBc-AP protocol (Ts 29.168) based write-replace messages from the CBC, which then sends S1AP based (Ts 25.419) write-replace messages to the appropriate base stations, determined by the CBC. In the case of UMTS (3G) the service area broadcast protocol (SABP) (Ts 25.419) write-replace messages can be sent direct to the base stations from the CBC. The prefix “Ts” above refers to 3GPP technical specifications.

An IP multimedia subsystem (IMS) 35 is also provided as part of the cellular network 29, being an architectural framework for delivering IP multimedia services. In the present embodiment, the emergency response centre 23 communicates with the cellular network 29 via the IMS 35 and the cellular network communicates with the web server 31 via the IMS.

Also shown in the cellular network 29 are first and second types of base station. For example, a home nodeB gateway (HNB-GW) 43 and HNB 45 is a base station serving a so-called 3G femtocell or small cell. As will be appreciated, a femtocell is similar to a conventional nodeB but is optimised for deployment in indoor premises and small coverage public hotspots. Another type of base station is a home enhancedNodeB, or HeNB 49 which is shown with its HeNB gateway (HeNB-GW 47.) The HeNB 49 is a base station serving an LTE (4G) femtocell or small cell.

Thus, the cellular network 29 is in the shown embodiment utilising small cells for more granular determination of the area within which events occur and/or the affected areas. However, larger cell sizes may be used in other embodiments, e.g. macro cells.

The web server 31 is any form of server hosting a feedback form 32, which may be provided in HTML or XML form and may be interactive. The dotted line surrounding the emergency response centre system 23 and the web server 31 indicate that the two may be co-located, which tends to be efficient in terms of determining the subsequent broadcast area(s) based on the feedback data.

The emergency response centre 23 is, as before in FIG. 1, a localised service for a particular country or geographical zone, typically comprising a hotline for receiving voice calls or SMSs reporting an emergency.

The federal/state emergency operation centre 27 is a public warning centre that monitors situations relating to, for example, earthquakes, flooding, tsunami, hurricanes and tornados.

Thus, both the emergency response centre 23 and the federal/state emergency operation centre 27 may receive and/or issue alert messages in present embodiments.

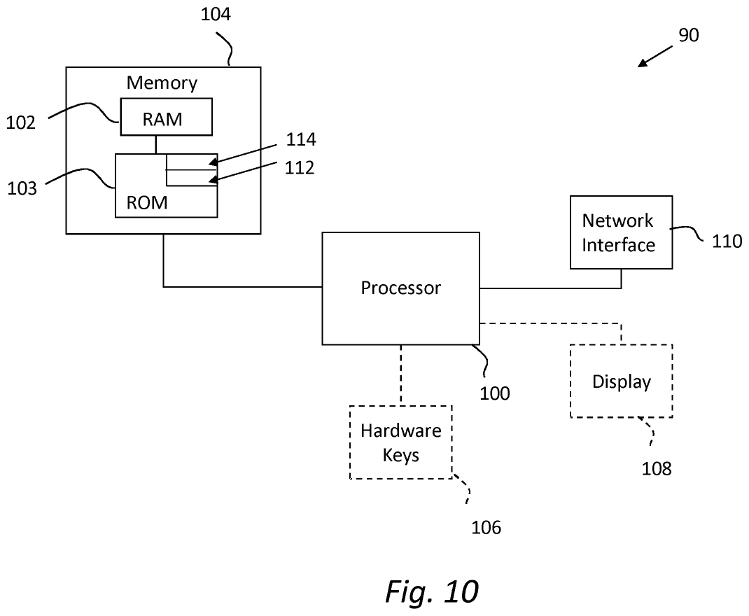

FIG. 10 is a schematic diagram of components of the emergency response centre 23. The emergency response centre 23 may have a processor 100, a memory 104 closely coupled to the processor and comprised of a RAM 102 and ROM 103, and, optionally, hardware keys 106 and a display 108. The processing system 90 may comprise one or more network interfaces 110 for connection to a network, e.g. a modem which may be wired or wireless.

The processor 100 is connected to each of the other components in order to control operation thereof.

The memory 104 may comprise a non-volatile memory, a hard disk drive (HDD) or a solid state drive (SSD). The ROM 103 of the memory 104 stores, amongst other things, an operating system 112 and may store software applications 114. The RAM 102 of the memory 104 may be used by the processor 100 for the temporary storage of data. The operating system 112 may contain code which, when executed by the processor ware components of the emergency response centre 23.

The processor 100 may take any suitable form. For instance, it may be a microcontroller, plural microcontrollers, a processor, or plural processors.

The emergency response centre 23 may be a standalone computer, a server, a console, or a network thereof.

In some embodiments, the emergency response centre 23 may also be associated with external software applications. These may be applications stored on a remote server device and may run partly or exclusively on the remote server device. These applications may be termed cloud-hosted applications. The emergency response centre 23 may be in communication with the remote server device in order to utilize the software application stored there.

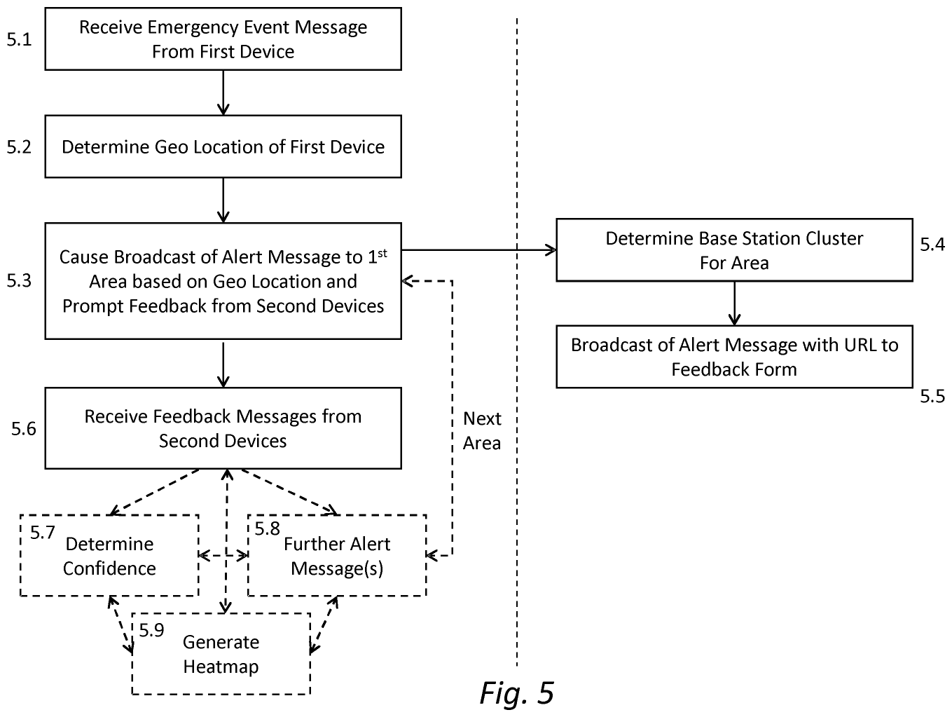

FIG. 5 is a flow diagram showing processing operations that may be performed by the emergency response centre 23, for example using one or more processing systems associated with the response centre. FIG. 5 also shows processing operations that may be performed by the cellular network 29. Certain operations may be optional and certain operations may be re-ordered. The number of operations is not necessarily indicative of the order of performance.

A first operation 5.1 comprises receiving an emergency event message from a first device.

Another operation 5.2 comprises the emergency response centre 23 determining the geolocation of the first device, e.g. using E-SMLC.

Another operation 5.3 comprises the emergency response centre 23 causing the cellular network 29 to broadcast an alert message to a first broadcast area, Area#1, based on the geolocation and to prompt feedback from second devices.

In this respect, the determined geolocation may correspond to a first cell, and the first broadcast area (Area#1) may be the first cell, or a cluster of cells including the first cell, or a cluster of cells not including the first cell but which surround the first cell, such as adjoining cells. Area#1 is in the vicinity of the first cell but is only a part of the overall network.

Another operation 5.4, performed at the cellular network 29, is determining the base station cluster for the determined broadcast area, Area#1. This is performed using the CBC 39 based on the determined geolocation of the first device.

Another operation 5.5, performed at the cellular network 29, is broadcasting the alert message with a prompt for feedback. In the present embodiment, this is by including a URL to the feedback form 32 stored on the web server 31.

Returning to the emergency response centre 23, another operation 5.6 comprises receiving feedback messages from one or more second devices which are within the first broadcast area, Area#1. Of course, not all second devices that received the alert message may provide feedback messages.

Subsequent operations 5.7, 5.8, 5.9 may correspond to optional operations in 2.5, 2.6, 2.7 mentioned above and, for example, may comprise causing broadcast of still further alert messages to different geographic areas, e.g. Area#2, Area#3 and so on, to build an idea of the geographic area impacted by the event.

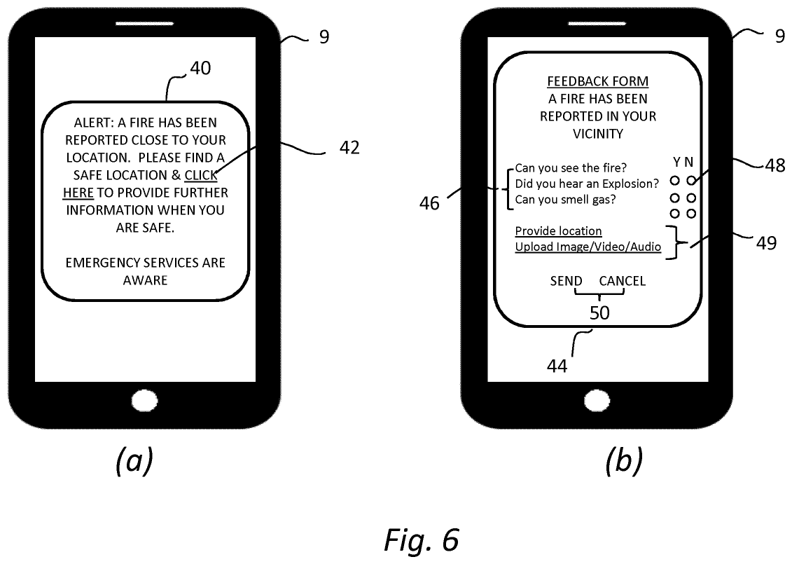

FIG. 6a is a screen shot of one of the second devices 9 within the cellular communications network when receiving an alert message 40 broadcast by a HNB 45 in the first area, Area#1. The same alert message 40 may be received by other second devices 9 within the first area, Area #1. In some embodiments, the alert message 40 may be tailored according to the second device's properties, such as its display size or type of software (e.g. browser) used.

The alert message 40 comprises information that indicates the type of alert, in this case a fire, that was entered by an operator at the emergency response centre 23. The alert message 4o further comprises a link 42 to a URL, selection of which causes retrieval over an IP network (via the IMS subsystem 35) of a corresponding feedback form in HTML or XML format, although other formats may be used.

FIG. 6b is a screen shot of the second device 9 responsive to activating the link 42, and displaying a feedback form 44. The feedback form 44 may repeat the type of alert, and may additionally prompt input of observational data 46 relating to the reported alert.

For example, in the shown example, a series of questions relating to observational data 46 are provided, including:

Can you see the fire?

Did you hear an explosion?

Can you smell gas?

Each question has an associated set of radio buttons 48, enabling yes or no feedback. In other embodiments, narrative feedback may be received by way of a text entry box.

The particular questions that are prompted in the feedback form 44 may be predetermined and particular to the type of alert. Replying “yes” to a particular question may prompt a new question to be displayed.

In FIG. 6b, one or more links 49 or buttons may be provided for enabling the user of the second device 9 to specify their location (most smartphones for example have an in-built GPS facility and can provide their own specific location) and/or to upload an image, video and/or audio. For example, in some embodiments, a camera application may be enabled in response to selection of the upload link or button, for enabling the user to capture a local image for sending back to the emergency response centre.

A set of send/cancel buttons 50 are provided for enabling sending the feedback message generated by means of the feedback form 44 to the emergency response centre 23.

Receipt by the emergency response centre 23, or some other facility, of the feedback messages may be used to determine a confidence score indicative as to whether the reported event is genuine or a hoax.

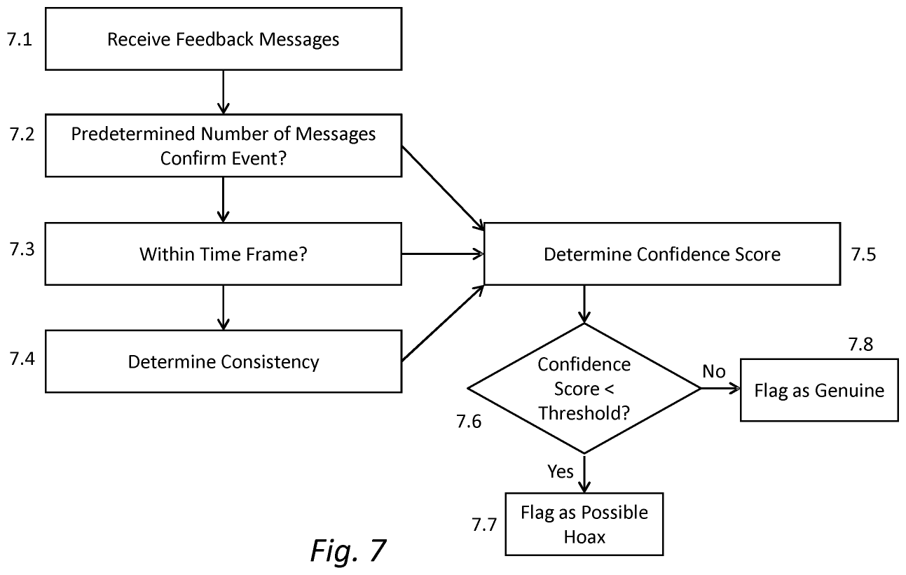

For example, FIG. 7 is a flow diagram showing processing operations that may be performed by the emergency response centre 23 in determining a confidence score relating to a reported event. Certain operations may be optional and certain operations may be re-ordered. The number of operations is not necessarily indicative of the order of performance.

A first operation 7.1 may comprise receiving feedback messages from the second communications devices.

A second operation 7.2 may comprise determining if a predetermined number of the feedback messages confirm the reported event. So, if the event relates to a fire, then it may be determined if there is at least one further confirmation of a visible fire in the first area, Area#1.

A third operation 7.3 may comprise determining if the confirming feedback messages occur within a predetermined time frame.

A fourth operation 7.4 may comprise determining the consistency of the feedback messages. For example, a first feedback message may indicate that the fire is at a first location and a second feedback message may indicate that the fire is at a second location, suggestive of a hoax promoted by multiple persons.

A further operation 7.5 may comprise taking the determined data from one or more of the operations 7.2, 7.3, 7.4 to determine a confidence score indicative of the likelihood that the reported event is genuine. This score may be a number between 1 and 100. A further operation 7.6 may comprise determining if the confidence score is below a predetermined threshold, e.g. 50. If so, the event may be flagged as a possible hoax in operation 7.7. If above the threshold, the event may be flagged as genuine in operation 7.8.

Analytics may be used to estimate the likelihood that a reported event is genuine or a hoax. A machine-learning algorithm may be employed, for example.

For example, if the feedback messages comprise data in the form of an image, an audio clip and/or a video clip, analysis may be applied to the data. This may involve storing one or more visual and/or audio signatures for different types of event, and assessing how closely the feedback data is to the signatures. For example, if the event relates to a fire, then analysis of a photographic image or video clip may attempt to detect signature characteristics indicative of flames or smoke. Prioritisation and/or filtering may be performed in response. If an audio clip, analysis against an expected range of sounds may be performed.

Alternatively, or additionally, a manual assessment of the provided image, audio and/or video clip may be performed. Provision of an image or video clip may enable immediate confirmation and, hence, provided data of this format may be prioritised for manual verification.

It should be noted that an event determined to be a possible hoax will not necessarily result in no emergency response being issued; it is likely that some form of response will be issued, but the above method at least enables the response to be tailored accordingly. This may involve lowering the priority afforded to a possible hoax event.

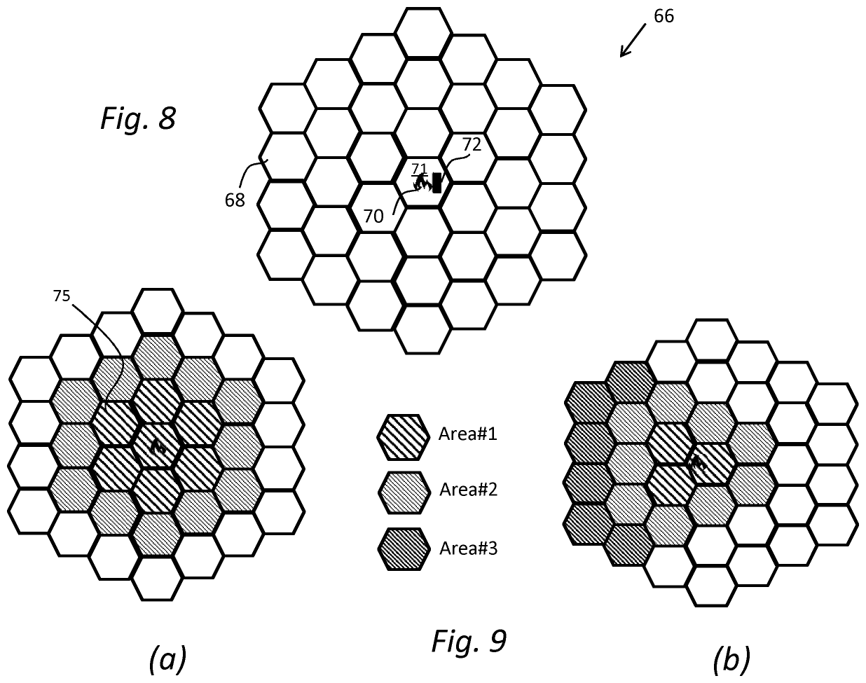

A more detailed example of the FIG. 5 method will now be explained with reference to FIG. 8, which is a schematic view of a geographic area 66 covered by a plurality of small cells 68, each having a respective base station HNB 45 (and/or HeNB 49.) In this example, an event 70 is shown within one of the cells 71.

In response to a first device 72 reporting the event 70 to the emergency response centre 23, the geolocation of the first device is determined.

It is then determined which area of the geographic area 66 the alert message should be broadcast to. For example, it may be determined that the alert message should be broadcast to devices within approximately 20 metres of the first device location. Information concerning the type of event and the determined area is sent to the CBC 39 of the cellular network 29 which then determines which HNBs 45 (and/or HeNBs 49) to use for the broadcast.

Referring to FIG. 9a, for example, it may be determined that the first area, Area#1, comprises a cell cluster comprising the local cell 71 containing the first device 72 and adjacent cells 75 which cover a 20 metre radius of the first device location.

The first alert message is broadcast from the corresponding HNBs 45 (and/or HeNBs 49) for the local cell 71 and the adjacent cells 75.

If the feedback messages from the second devices in the cell cluster are indicative that the reported event is genuine, a second iteration involving a second alert message may be performed. This may involve sending the same alert message to a wider area of, say, 40 metres from the first device location. The CBC 39 of the cellular network 29 3o determines which HNBs 45 (and/or HeNBs 49) to use for the broadcast. Referring again to FIG. 9a, the second area, Area#2, may comprise a second cell cluster which covers a 40 metre radius of the first device location, but does not include the first cell cluster 75. In this way, spectrum is utilised efficiently by not repeating the previous broadcast.

The second alert message is broadcast from the corresponding HNBs 45 (and/or HeNBs 49) for the Area#2 cell cluster.

The process may be repeated until little or no feedback messages are received which positively confirm the event. For example, a third area, Area#3 is also shown.

In some embodiments, analytical algorithms may be employed to estimate the impact and the resulting area. For example, if a fire is reported in a first cell, and the prevailing weather conditions indicate a wind direction and speed, analytics may determine the area to send alert messages in a subsequent iteration based on the predicted area covered by the fire in the near future.

The resulting ‘heat map’ produced provides an intuitive graphical representation of the effect of the event, and its scale. Appropriate resourcing decisions can be made based on the affected area and the relative locations.

FIG. 9b shows an alternative situation in which the event 70 is close to a local cell edge.

In this situation, the first area, area#1 may comprise the local cell 71 and the two cells within 20 metres of the first device location.

A second alert message may be broadcast from the corresponding HNBs 45 (and/or HeNBs 49) for the Area#1 cell cluster.

If the feedback messages from second devices in the Area#1 cell cluster are indicative that the reported event is genuine, a second iteration involving a second alert message may be performed. This may involve sending the same alert message to a wider area of, say, 40 metres from the first device location. The CBC 39 of the cellular network 29 determines which HNBs 45 (and/or HeNBs 49) to use for the broadcast. Referring to FIG. 9b, the second area, Area#2, may comprise a second cell cluster which covers a 40 metre radius of the first device location, but does not include the first cell cluster 75. Due to the first device 72 being close to a cell edge, the developing heat map may be asymmetric.

Further, the second or further area(s) may be determined based on the feedback. For example, if positive confirmation of the event 70 is received in mainly from Area#2 cells to the left of the device location, with relatively few coming from the right-hand side, then the third area, Area#3, may be based on that observation. As shown in FIG. 9b, the third area, Area#3 comprises cells primarily to the left of the first device location.

In generating such a heat map based on feedback messages, it becomes clear in a relatively short time-span where the affected areas are and how large the overall affected area is. If iterations of further broadcast alert messages continue, it will also become clear how quickly the effect of the event is developing, all of which provides useful insight data to the appropriate emergency services.

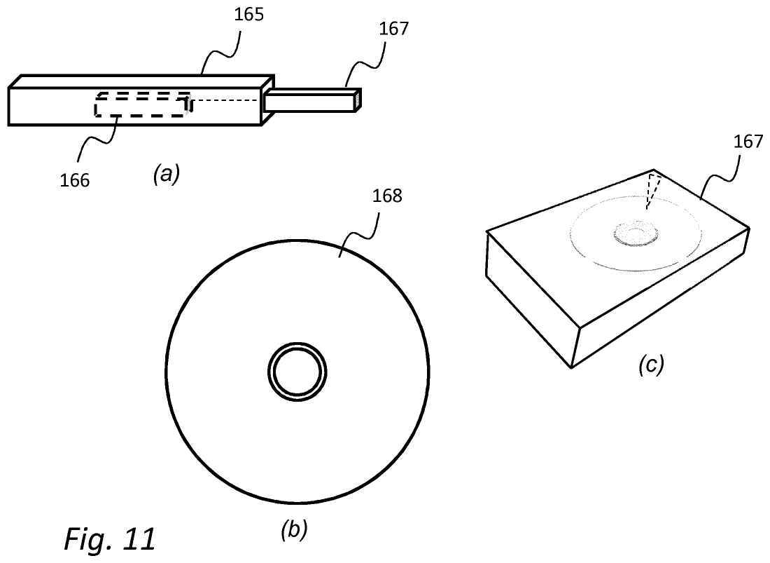

For completeness, and following on from FIG. 10 already described previously, FIGS. 11a and 11b show tangible media, respectively a removable memory unit 165 and a compact disc (CD) 168, storing computer-readable code which when run by a computer may perform methods according to embodiments described above. The removable memory unit 165 may be a memory stick, e.g. a USB memory stick, having internal memory 166 storing the computer-readable code. The memory 166 may be accessed by a computer system via a connector 167. The CD 168 may be a CD-ROM or a DVD or similar. Other forms of tangible storage media may be used. For example, FIG. 11c shows a hard disk drive (HDD) 167 which can equally be a solid state drive (SSD.)

Advantageously, the disclosed method and system may improve reliability when an emergency call is made, for example to filter out hoax calls from genuine ones. Also, the emergency response centre may dedicate their response operations to the correct location based on user feedback, even when calls are made with the aim of diverting rescue operations. By selecting smaller areas for sending alerts on an iterative basis, there is less change of causing unnecessary panic among the public, and avoids disabling alerting systems due to false alarms. By focusing the alerts initially in the vicinity of the determined incident area, and then expanding the coverage area, people in close range of the event are appropriate alerted, and then people further away may be alerted subsequently. The system may become publicly trusted as a result of the above and active participation in providing feedback may be encouraged.

In some embodiments, analytical algorithms may be employed to estimate the impact and the resulting area. For example, if a fire is reported in a first cell, and the prevailing weather conditions indicate a wind direction and speed, analytics may determine the area to send alert messages to in a subsequent iteration based on the predicted area covered by the fire in the near future. Similarly, in the event of a reported flood event, analytics may determine the area to send alert messages to, based on future rainfall in a particular area.

It will be appreciated that the above described embodiments are purely illustrative and are not limiting on the scope of the invention. Other variations and modifications will be apparent to persons skilled in the art upon reading the present application.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1-30. (canceled)

31. A method comprising:
receiving a first message over a communications network from a first communications device, the message relating to an emergency event;
determining the geographic location of the first communications device;
causing transmission of an alert message to one or more second communications devices within a first area based on the determined location, the alert message providing an indication of the emergency event and prompting feedback by means of the second communications devices relating to the emergency event; and
receiving one or more feedback messages relating to the emergency event from one or more of the second communications devices.

32. The method of claim 31, further comprising determining the validity of the first message based on the received feedback messages.

33. The method of claim 32, wherein determining the validity comprises identifying the first message as valid if a predetermined number of feedback messages positively confirming the emergency event are received.

34. The method of claim 33, wherein determining the validity comprises identifying the first message as valid if the predetermined number of feedback messages are received within a predetermined time frame from when the alert message was caused to be transmitted.

35. The method of claim 33, wherein determining the validity comprises identifying the first message as valid if the predetermined number of feedback messages provide feedback determined as being consistent with each other.

36. The method of claim 31, wherein the received feedback messages comprise observational data relating to the emergency event, the observational data relating to one or more of visibility of the emergency event, audibility of the emergency event, smell from the emergency event, relative location.

37. The method of claim 31 wherein the received feedback message comprises the geographic location of the second communications device from which the feedback message was received.

38. The method of claim 31, wherein causing transmission of the alert message comprises causing transmission of a feedback form prompting input of the feedback and for sending to a predetermined system.

39. The method of claim 38, wherein the transmitted feedback form comprises one or more alphanumeric text entry fields, each associated with a predefined observation relating to the emergency event, for receiving alphanumeric text relating to the emergency event.

40. The method of claim 38, wherein the transmitted feedback form further comprises a means to upload or attach one or more of a photograph, video, and audio clip.

41. The method of claim 40, wherein the transmitted feedback form automatically opens one or more of a camera or audio recording application at the one or more second communications devices in response to being received, opened or activated.

42. The method of claim 31, wherein causing transmission of the alert message to second communications devices within a first area comprises causing transmission only to a first sub-set of cells of a cellular communications network, the first sub-set being determined based on the received geographic location.

43. The method of claim 42, wherein the first sub-set of cells comprise and/or surround the received geographic location.

44. The method of claim 42, wherein the first sub-set of cells surround a cell having an associated base station which is closest to the first communications device.

45. The method of claim 31, further comprising causing transmission of the alert message to one or more communications devices within a second area based on the determined location, the second area being different from the first area; and
receiving one or more feedback messages relating to the emergency event from one or more of the communications devices in the second area.

46. The method of claim 45, when dependent on any of claims 17 to 19, wherein causing transmission of the alert message to the communications devices within the second area comprises causing transmission only to a second sub-set of cells of the cellular communications network, different from the first sub-set of cells.

47. The method of claim 45, wherein the second area is determined based on the determined location and environmental data, e.g. weather conditions and user feedback data analysis from the first area.

48. The method of claim 31, further comprising generating a map, being a two or more-dimensional graphical representation based on the feedback messages indicative of positive feedback in relation to the first communications device.

49. A non-transitory computer-readable storage medium having stored thereon computer-readable code, which, when executed by at least one processor, causes the at least one processor to perform a method, comprising:
receiving a first message over a communications network from a first communications device, the message relating to an emergency event;
determining the geographic location of the first communications device;
causing transmission of an alert message to one or more second communications devices within a first area based on the determined location, the alert message providing an indication of the emergency event and prompting feedback by means of the second communications devices relating to the emergency event; and
receiving one or more feedback messages relating to the emergency event from one or more of the second communications devices.

50. An apparatus, the apparatus having at least one processor and at least one memory having computer-readable code stored thereon which when executed controls the at least one processor:
to receive a first message over a communications network from a first communications device, the message relating to an emergency event;
to determine the geographic location of the first communications device;
to cause transmission of an alert message to one or more second communications devices within a first area based on the determined location, the alert message providing an indication of the emergency event and prompting feedback by means of the second communications devices relating to the emergency event; and
to receive one or more feedback messages relating to the emergency event from one or more of the second communications devices.
